(19) United States
(12) Patent Application Publication
(10) Pub. No.: US 2022/0125657 A1
(43) Pub. Date: Apr. 28, 2022

(54) DISEASE TRANSMISSION PREVENTING MASSAGE TABLE COVER

(71) Applicant: Stephanie Farrington, Stittsville (CA)

(72) Inventor: Stephanie Farrington, Stittsville (CA)

(21) Appl. No.: 17/079,675

(22) Filed: Oct. 26, 2020

(51) Int. Cl. A61G 13/12; A61G 13/10; A61G 13/00

(52) U.S. Cl. CPC A61G 13/121; A61G 13/009; A61G 13/102

(57) ABSTRACT

A cover for covering a face cradle on a massage table includes a cover body for attachment to the face cradle and a matter catching means attached to the cover body. The matter catching means includes a bag-like body for sealing a face opening in the face cradle and preventing particles such as droplets and droplet nuclei expelled from a mouth and/or nose of the user from flowing therethrough. The cover is thus used for preventing disease transmission through pathogenic matter expelled from the mouth and/or nose of the user.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of massage tables and/or therapeutic tables of a similar design of existing art and more specifically relates to a device for covering a face cradle of a massage table and for preventing disease transmission via matter expelled from a massage patient's mouth and/or nose.

### RELATED ART

Face masks and respirators are used to cover the mouth and nose of a wearer in order to shield them, and others around them, from particles containing pathogenic matter. During the COVID-19 pandemic, face masks were employed as a public health control measure to slow the spread of the novel coronavirus. Due to the pandemic, many businesses required their customers to wear face masks to enter their premises or receive their services. This was to protect other customers and staff from disease transmission via airborne particles or droplets produced when an individual breathes, talks, coughs, sneezes, etc.

It is particularly important for spas or facilities providing health services (such as massage or physiotherapy) to employ health control measures due to the close proximity of patients to staff. As such, many of these facilities require that a patient wear a face mask during services, particularly massage services. However, when the patients face is positioned in the face cradle it becomes uncomfortable for them, as their face mask is pulled tight across their face, making breathing difficult. Due to this, patients have to keep moving their mask to a more comfortable position or completely remove their face mask when faced down. This is a problem, firstly because constant movement from the patient is disruptive and prevents the patient from fully relaxing. Secondly because removal of the face mask puts the massage therapist and patient at risk, as the face cradle allows for open air exchange of potentially infectious particles. Thus, a suitable solution is desired.

### SUMMARY OF THE INVENTION

In view of the foregoing disadvantages inherent in the known massage table cover art, the present disclosure provides a novel disease transmission preventing massage table cover. The general purpose of the present disclosure, which will be described subsequently in greater detail, is to provide a means of covering the face cradle and preventing, or at least partially preventing, matter expelled from a mouth and/or nose of a patient from traveling through an opening of the face cradle. This may reduce the prevalence of potentially pathogenic particles in the air, protecting the patient and massage practitioner from open air exchange, thus reducing the spread of infectious diseases.

A cover for covering a face cradle on a massage table (“cover”) is disclosed herein. The face cradle may include a cradle body defining a face opening therein configured to removably receive a face of a user. The cover may include a cover body and a matter catching means. The cover may be configured to attach to the cradle body via an attachment means. The cover body may define an inner section and outer section relative to the cradle body when attached thereto and the inner section may border the face opening of the face cradle.

The cover may further include a matter catching means fixedly attached about the inner section of the cover body. The matter catching means may include a body assembled to form a partially-open enclosure. The enclosure may include an open top bordering the face opening and a closed bottom extending through the face opening when the cover body is attached to the cradle body. The matter catching means may be configured to seal the face opening such that particles expelled from a mouth and/or nose of the user are prevented from flowing therethrough.

According to another embodiment, a method for using a cover for covering a face cradle on a massage table (“method”) is also disclosed herein. The method may include providing the cover as above; attaching the cover body to the cradle body via the attachment means; and arranging the matter catching means, ensuring the closed bottom extends through the face opening.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, disease transmission preventing massage table cover, constructed and operative according to the teachings of the present disclosure.

FIG. 1 is a side view of a device during an ‘in-use’ condition, according to an embodiment of the disclosure.

FIG. 2 is a top front view of the device of FIG. 1, according to an embodiment of the present disclosure.

FIG. 3 is a bottom view of the device of FIG. 1, according to an embodiment of the present disclosure.

FIG. 4 is a side view of the device of FIG. 1, according to an embodiment of the present disclosure.

FIG. 5 is a flow diagram illustrating a method for covering a face cradle on a massage table, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cover for a face cradle of a massage table and more particularly to a disease transmission preventing massage table cover as used to substantially inhibit particles expelled from a mouth and/or nose of a user from flowing through a face opening in the face cradle.

Generally disclosed is a cover that is placed over the face cradle on the massage table and includes a pocket/bag-like portion to seal the face opening and prevent particles from entering the air underneath the massage table. The cover and the pocket/bag-like portion may be one piece of material that is breathable. This may allow massage patients to feel safe and comfortable whilst getting their massage and will limit airborne particles from being transmitted.

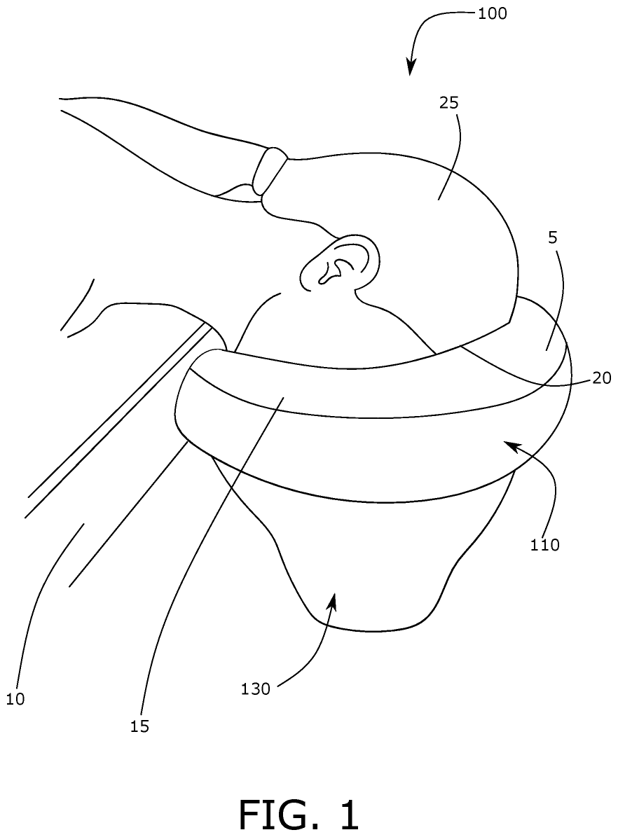

Referring now more specifically to the drawings by numerals of reference, there is shown in FIGS. 1-4, various views of a cover for covering a face cradle (“cover” 100).

FIG. 1 shows a cover 100 during an ‘in-use’ condition, according to an embodiment of the present disclosure. As illustrated, the cover 100 may include a cover body 110 and a matter catching means 130. The cover 100 may be used for covering a face cradle 5 on a massage table 10, the face cradle 5 including a cradle body 15 defining a face opening 20 therein configured to receive a face of a user 25.

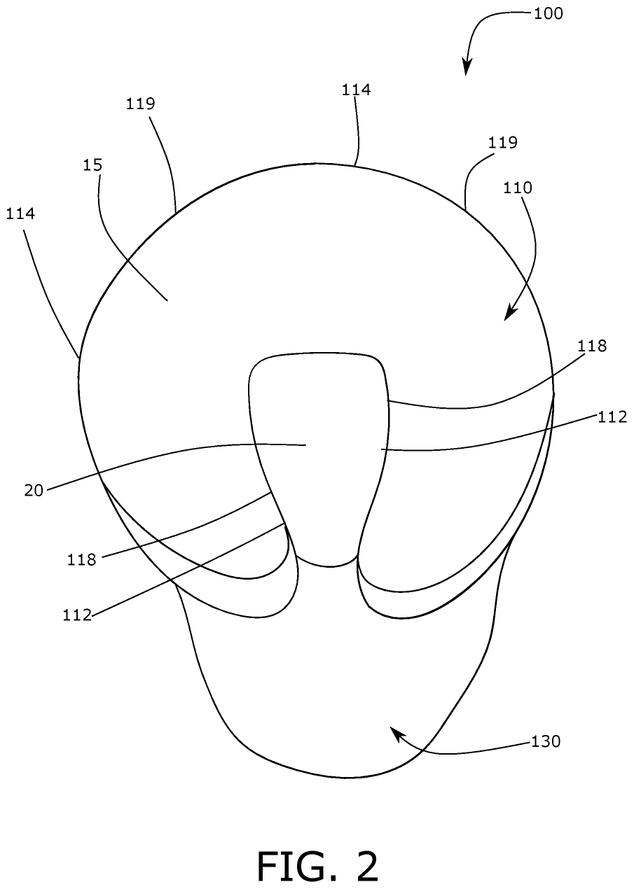

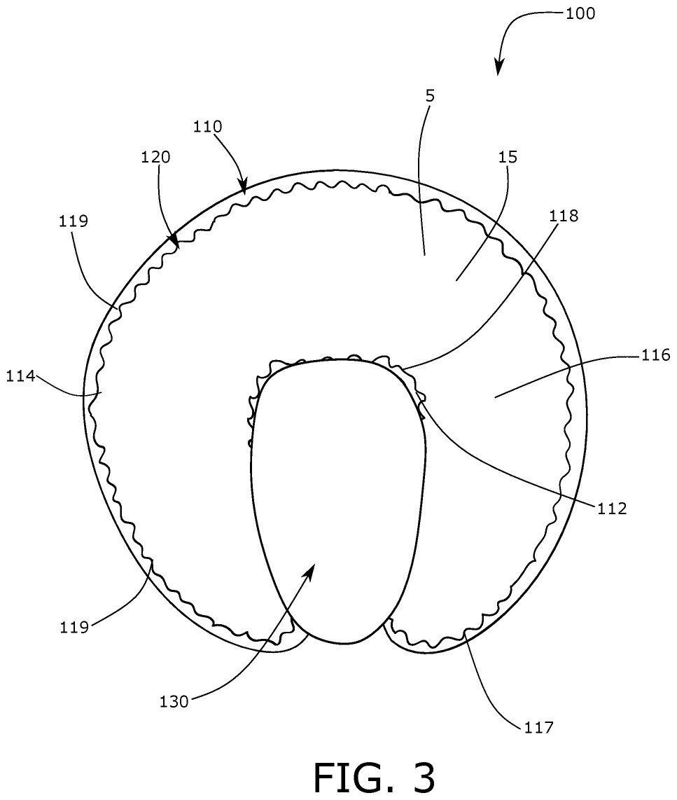

Referring now to FIGS. 2-3 showing a top front view and a bottom view of the cover 100 of FIG. 1, according to an embodiment of the present disclosure. The cover body 110 may be configured to attach to the cradle body 15 via an attachment means 120, and may further include a cover opening 116 configured for receiving the cradle body 15. The cover opening 116 may include a periphery 117 and the attachment means 120 may be located about the periphery 117. Preferably, the attachment means 120 may include elastic material. For example, the elastic material may be strips of elastic, or an elastic band. The elastic material may be attached to the periphery 117, such as via sewing or adhesive. The elastic material may provide stretch to the cover body 110 such that a user 25 may easily expand the cover opening 116 to fit it over the cradle body 15. Once attached to the cradle body 15 the elastic material may cling to a bottom of the cradle body 15 (as shown in FIG. 3).

Further, the cover body 110 may define an inner section 112 and outer section 114 relative to the cradle body 15 when attached thereto. As shown, the inner section 112 may border the face opening 20. The periphery 117 may include an inner edge 118 located on the inner section 112 of the cover body 110 and an outer edge 119 located on the outer section 114 of the cover body 110.

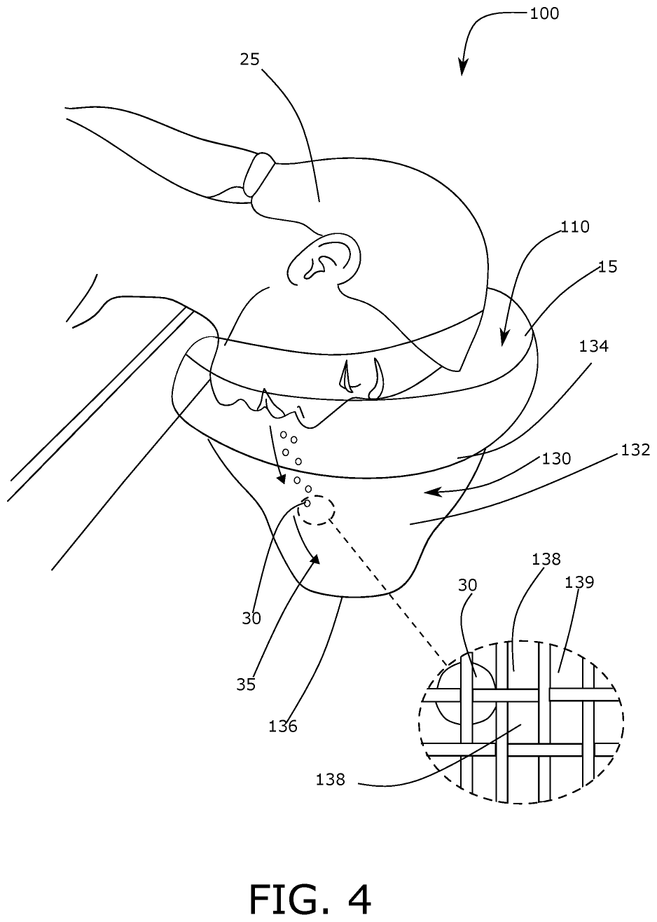

Referring now to FIG. 4 showing a side view of the cover 100 of FIG. 1, according to an embodiment of the present disclosure. The cover 110 is shown to be transparent in this figure to better illustrate airflow 35 and particles 30. Further, for illustrative purposes the particles 30 are not shown to scale. The matter catching means 130 may preferably be fixedly attached about the inner section 112 of the cover body 110. Specifically, the matter catching means 130 may be fixedly attached to the inner edge 118 of the periphery 117. Preferably, the matter catching means 130 may be integral to the cover body 110. For example, the matter catching means 130 and the cover body 110 may be formed from one piece of material. In this example, the matter catching means 130 may be one and the same with the inner section 112 of the cover body 110. In other examples, the matter catching means 130 may be a separate piece of material attached to the cover body 110 via permanent fasteners, or semi-permanent fasteners such as sewing, adhesive, etc. In some embodiments, the matter catching means 130 may be removably attached to the cover body 110 via temporary fasteners such as hook and loop fastener, buttons, snap fasteners, etc.

Preferably at least one of the matter catching means 130 and the cover body 110 may comprise a washable material so that the cover 100 may be disinfected and reused. In other embodiments, at least one of the matter catching means 130 and the cover body 110 may comprise a disposable material. Where the matter catching means 130 and the cover body 110 are made from one piece of material, they may both either be washable or disposable.

The matter catching means 130 may include a body 132 assembled to form a partially-open enclosure. The enclosure may include an open top 134 bordering the face opening 20 and a closed bottom 136 extending through the face opening 20 when the cover body 110 is attached to the cradle body 15. Preferably, the one piece of material may be flexible for allowing the cover body 110 to easily conform to the cradle body 15, and to allow the closed bottom 136 to be positioned through the face opening 20.

The matter catching means 130 may be configured to seal the face opening 20 such that particles 30 expelled from at least one of a mouth and a nose of the user 25 may be substantially prevented from flowing therethrough. When the user 25 places their face within the open top 134 of the enclosure, the open top 134 may be closed, forming a completely sealed enclosure whereby the particles 30 are prevented from escaping through any area of the matter catching means 130. The particles 30 may be carried in droplets, such as respiratory droplets consisting of a small droplet of saliva, mucus or other matter or droplet nuclei (or aerosols) consisting of solid or liquid matter suspended in air. These aerosols and respiratory droplets may be produced by breathing, talking, sneezing, coughing, etc. and the matter contained in the aerosols and respiratory droplets may contain disease or infection producing pathogens or organisms. As such, the matter catching means 130 may prevent, or at least substantially prevent disease transmission from the potential pathogenic matter contained in the aerosols or respiratory droplets.

As shown, the matter catching means 130 may include a bag-like or pouch-like body. The closed bottom 136 of the matter catching means 130 may prevent the particles 30 from escaping therethrough, along with the open top 134 when the face of the user 25 is placed within the face opening 20 (which therefore closes the open top 134). To achieve this, the matter catching means 130 may include filtering means 139 to prevent or at least inhibit the particles 30 from penetrating through the closed bottom 136 (or sides/top of the matter catching means 130).

Preferably, the matter catching means 130 may comprise a breathable material to allow adequate airflow 35, whilst maintaining the ability to trap the particles 30. In some embodiments, the filtering means 139 may be a feature of a material used to make the matter catching means 130. For example, the matter catching means 130 may be woven, spun, knit, etc. in such a way as to trap particles 30 therein. Small apertures 138 may be formed by interlaced or interlocked yarns or threads when the matter catching means 130 is made, as shown in FIG. 4 (for illustrative purposes these apertures 138 are not shown to scale). These apertures 138 may be large enough to allow the adequate airflow 35 so that the user 25 can breathe, but small enough to prevent (or at least substantially prevent) the particles 30 from escaping therethrough.

The ability of the matter catching means 130 to capture or filter the particles 30 may rely on material of the matter catching means, how that material is used to make the matter catching means 130 and a size of the apertures 138 (formed by the interlaced/interlocked yards or threads), as well as any additional filtering means 139. For example, the apertures 138 may be sized to capture particles 30 having a size of at least 5 μm (micrometers), and larger. This example may only allow for the filtering of respiratory droplets, as they are larger in size than aerosols. In other embodiments, the apertures 138 may be sized to capture particles 130 having a size of less than 5 μm.

In other embodiments, the filtering means 139 may be added to the matter catching means 130. For example, the filtering means 139 may be a nonwoven material such as polypropylene, cartridges containing chemicals such as activated charcoal, fans or blowers, and the like. The filtering means 139 may be configured to filter particles 30 having a size of at least 100 nm (nanometers) or larger. In any embodiment it is intended that the matter catching means 130 be configured to prevent escape or penetration of the particles 30 at least to the extent that cloth face masks or surgical face masks do.

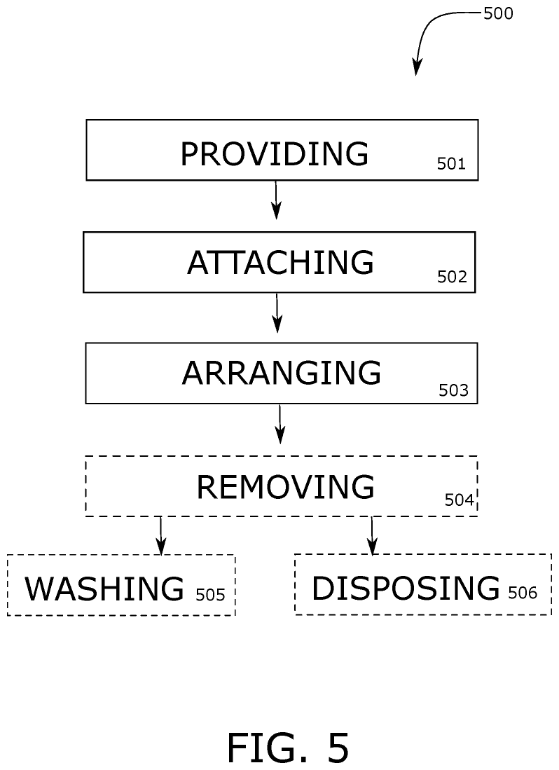

Referring now to FIG. 5 showing a flow diagram illustrating a method for covering a face cradle on a massage table 500, according to an embodiment of the present disclosure. In particular, the method 500 may include one or more components or features of the cover 100 as described above. As illustrated, the method of use 500 may include the steps of: step one 501, providing the cover as above; step two 502, attaching the cover body to the cradle body via the attachment means; and step three 503, arranging the matter catching means ensuring the closed bottom extends through the face opening. In one embodiment, further steps may include: step four 504, removing the cover body from the cradle body; and step five 505, washing the cover for re-use. In another embodiment, further steps may the step four 504 of removing the cover body from the cradle body, and step six 506, disposing of the cover.

It should be noted that steps four 504, five 504 and six 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for covering a face cradle on a massage table are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cover for covering a face cradle on a massage table, the face cradle including a cradle body defining a face opening therein configured to receive a face of a user, the cover comprising:
a cover body configured to attach to the cradle body via an attachment means, the cover body defining an inner section and outer section relative to the cradle body when attached thereto, the inner section bordering the face opening; and
a matter catching means fixedly attached about the inner section of the cover body, the matter catching means including a body assembled to form a partially-open enclosure, the enclosure including an open top bordering the face opening and a closed bottom extending through the face opening when the cover body is attached to the cradle body, the matter catching means configured to seal the face opening such that particles expelled from at least one of a mouth and a nose of the user are substantially prevented from flowing therethrough.

2. The cover of claim 1, wherein the cover body includes a cover opening configured for receiving the cradle body.

3. The cover of claim 2, wherein the cover opening includes a periphery.

4. The cover of claim 3, wherein the periphery includes an inner edge located on the inner section of the cover body.

5. The cover of claim 4, wherein the periphery further includes an outer edge located on the outer section of the cover body.

6. The cover of claim 5, wherein the matter catching means is fixedly attached to the inner edge of the periphery.

7. The cover of claim 6, wherein the matter catching means is integral to the cover body.

8. The cover of claim 7, wherein the matter catching means and the cover body are formed from one piece of material.

9. The cover of claim 8, wherein the one piece of material is flexible.

10. The cover of claim 9, wherein the matter catching means comprises a breathable material.

11. The cover of claim 10, wherein at least one of the matter catching means and the cover body comprises a washable material.

12. The cover of claim 10, wherein said at least one of the matter catching means and the cover body matter catching means comprises a disposable material.

13. The cover of claim 1, wherein the attachment means is located about the periphery.

14. The cover of claim 13, wherein the attachment means includes elastic material.

15. A cover for covering a face cradle on a massage table, the face cradle including a cradle body defining a face opening therein configured to receive a face of a user, the cover comprising:
one piece of flexible material, the one piece of flexible material including:
a cover body configured to attach to the cradle body, the cover body defining an inner section and outer section relative to the cradle body when attached thereto, the inner section bordering the face opening, the cover body further including a cover opening including a periphery, the cover opening configured for receiving the cradle body, the periphery including an inner edge located on the inner section of the cover body and an outer edge located on the outer section of the cover body, the periphery including an attachment means configured to attach the cover body to the cradle body, the attachment means including elastic material; and
a matter catching means fixedly attached to the inner edge of the periphery, the matter catching means comprising a breathable material and including a body assembled to form a partially-open enclosure, the enclosure including an open top bordering the face opening and a closed bottom extending through the face opening when the cover body is attached to the cradle body, the matter catching means configured to seal the face opening such that particles expelled from at least one of a mouth and a nose of the user are substantially prevented from flowing therethrough.

16. The cover of claim 15, wherein at least one of the matter catching means and the cover body comprises a washable material.

17. The cover of claim 15, wherein at least one of the matter catching means and the cover body comprises a disposable material.

18. A method for covering a face cradle on a massage table, the face cradle including a cradle body defining a face opening therein configured to receive a face of a user, the method comprising:
providing a cover, the cover including:
a cover body configured to attach to the cradle body via an attachment means, the cover body defining an inner section and outer section relative to the cradle body when attached thereto, the inner section bordering the face opening; and
a matter catching means fixedly attached about the inner section of the cover body, the matter catching means including a body assembled to form a partially-open enclosure, the enclosure including an open top bordering the face opening and a closed bottom extending through the face opening when the cover body is attached to the cradle body, the matter catching means configured to seal the face opening such that particles expelled from at least one of a mouth and a nose of the user are substantially prevented from flowing therethrough;
attaching the cover body to the cradle body via the attachment means; and
arranging the matter catching means ensuring the closed bottom extends through the face opening.

19. The method of claim 18, further comprising the steps of:
removing the cover body from the cradle body; and
washing the cover for re-use.

20. The method of claim 19, further comprising the steps of:
removing the cover body from the cradle body; and
disposing of the cover.
